(19) United States
(12) Patent Application Publication
(10) Pub. No.: US 2018/0016410 A1
(43) Pub. Date: Jan. 18, 2018

(54) PLASTIC COMPOSITION, COMPOSITE FLOOR INCLUDING PLASTIC COMPOSITION AND PREPARATION METHOD THEREOF

(71) Applicant: JIANGSU SEMAO BAMBOO AND WOOD INDUSTRY CO., LTD, Jiangsu (CN)

(72) Inventors: Hailiang LIU, Jiangsu (CN); Songjie KANG, Jiangsu (CN); Qiaosheng LIU, Jiangsu (CN)

(21) Appl. No.: 15/550,926

(22) PCT Filed: Dec. 31, 2015
(86) PCT No.: PCT/CN2015/100070

§ 371 Date: Aug. 14, 2017

(30) Foreign Application Priority Data
May 22, 2015 (CN) 201510267920.4

(51) Int. Cl. C08K 3/26; B29C 47/00; E04F 15/04; B29C 47/12; B32B 3/30; C08K 3/08; C08J 9/04; B32B 37/12; B32B 37/10; B32B 37/08; B32B 27/30; E04F 15/10; B32B 27/06; B29L 31/10

(52) U.S. Cl. CPC C08K 3/26; E04F 15/107; B29C 47/0004; E04F 15/043; E04F 15/105; B29C 47/12; B32B 3/30; B32B 27/06; C08K 3/08; C08J 9/04; B32B 37/12; B32B 37/10; B32B 37/08; B32B 27/30; B29L 2031/10; C08J 2327/06; B32B 2451/00; C08K 2003/265

(57) ABSTRACT

The present invention discloses a plastic composition, a composite floor including the plastic composition and a preparation method thereof. The plastic composition is prepared from the following components in parts by weight: 30-55 parts of polyvinyl chloride, 35-55 parts of limestone powder, 0.5-5 parts of polyurethane foaming agent and 0.5-5 parts of stabilizer. The composite floor includes a decoration layer and a supporting layer, wherein the supporting layer is prepared from the plastic composition. The composite floor provided by the present invention has the advantages of simple structure, beautiful and elegant appearance, and good anti-water, anti-insect and anti-mildew effects. Moreover, the composite floor can effectively save wood resources, is low in cost and is more environmentally friendly.

### FIELD OF THE INVENTION

The present invention relates to the field of decorative sheets, in particular to a plastic composition, a composite floor including the plastic composition and a preparation method thereof.

### BACKGROUND OF THE INVENTION

The traditional floors are all solid plate bodies, and after a long time of use, especially in humid environments, the floors are prone to mildew, which seriously affects the user experience. Subsequent wood-plastic composite boards are prepared by mixing plastic and wooden powder according to a certain proportion and then performing hot extrusion molding on the mixture, the production process is complex, the requirements are high, and the production cost is high, so the wood-plastic composite boards are not suitable for large-scale promotion.

Therefore, it is urgent to propose a plastic composition of which a preparation method is simple, a composite floor having the advantages of simple structure, beautiful and elegant appearance, capability of effectively reducing the production cost, and anti-water, anti-insect and anti-mildew effects, and a preparation method thereof.

### SUMMARY OF THE INVENTION

In order to solve the above technical problems, the present invention provides a plastic composition, a composite floor including the plastic composition and a preparation method thereof. The composite floor has the advantages of simple structure, beautiful and elegant appearance, and good anti-water, anti-insect and anti-mildew effects. Moreover, the composite floor can effectively save wood resources, is low in cost and is more environmentally friendly.

To achieve the above objective, the technical solutions of the present invention are as follows:

a plastic composition is characterized by being prepared from the following components in parts by weight: 30-55 parts of polyvinyl chloride, 35-55 parts of limestone powder, 0.5-5 parts of polyurethane foaming agent and 0.5-5 parts of stabilizer.

The stabilizer is a calcium-zinc stabilizer.

A composite floor includes a decoration layer and a supporting layer, wherein the supporting layer is prepared from the plastic composition.

As the supporting layer of the composite floor provided by the present invention is prepared from the plastic composition, the composite floor has good anti-water, anti-insect and anti-mildew effects. Moreover, by means of the plasticity of the plastic composition, the composite floor is unlikely to deform and is longer in service life.

On the basis of the above-mentioned technical solutions, the following improvements can also be made:

as a preferred solution, preferably, the plastic composition is prepared from the following components in parts by weight: 35-50 parts of polyvinyl chloride, 40-50 parts of limestone powder, 0.5-2 parts of polyurethane foaming agent and 0.5-2 parts of stabilizer.

By adoption of the above-mentioned preferred solution, the flexibility and the hardness of the plastic composition are unified, and the supporting layer prepared from the same is firm in structure, unlikely to deform and is easy to process.

As a preferred solution, the decoration layer is prepared from one or more materials of wood, bamboo, scrimber and decorative paper.

By adoption of the above-mentioned preferred solution, as the decoration layer is prepared from one or more materials of wood, bamboo, scrimber and decorative paper, and the appearance is smooth, beautiful and elegant.

As a preferred solution, the supporting layer includes a front face and a back face, wherein the front face of the supporting layer is provided with the decoration layer or the front face and the back face of the supporting layer are both provided with the decoration layer respectively.

By adoption of the above-mentioned preferred solution, the structure is simple. The decoration layer plays a decoration role, and the supporting layer serving as a substrate of the composite floor plays a supporting role.

As a preferred solution, the front face and/or the back face of the supporting layer is provided with supporting ridges and/or supporting grooves, and the decoration layer is provided with decoration grooves and/or decoration ridges matched with the supporting ridges and/or the supporting grooves.

By adoption of the above-mentioned preferred solution, a firmer connection between the supporting layer and the decoration layer is guaranteed.

As a preferred solution, the section of each supporting ridge and/or each supporting groove is dovetail-shaped.

By adoption of the above-mentioned preferred solution, a flatter connection between the supporting layer and the decoration layer is guaranteed.

As a preferred solution, the front face and/or the back face of the supporting layer is provided with the supporting ridges and the supporting grooves, and the supporting ridges and the supporting grooves are arranged at equal intervals.

By adoption of the above-mentioned preferred solution, a firmer connection between the supporting layer and the decoration layer is guaranteed, and the stress on each part of the supporting layer and the decoration layer is more uniform.

A preparation method of a composite floor, used for preparing the composite floor, is characterized by including the following steps:

(1) burdening: preparing materials according to 30-55 parts of polyvinyl chloride, 35-55 parts of limestone powder, 0.5-5 parts of polyurethane foaming agent and 0.5-5 parts of stabilizer;

(2) mixing: performing heating and pressurization mixing on the polyvinyl chloride, the limestone powder, the polyurethane foaming agent and the stabilizer to form a mixture;

(3) extrusion molding: forming a plastic composition from the mixture through an extrusion molding die;

(4) cooling: performing cooling forming on the plastic composition subjected to extrusion molding;

(5) cutting: cutting the plastic composition subjected to cooling forming to form a supporting layer;

(6) laminating: putting a decoration layer and the supporting layer in a press in sequence, coating contact surfaces of the decoration layer and the supporting layer with cold pressing glue, and laminating the decoration layer and the supporting layer by the press to form the composite floor.

The technological process of the preparation method of the composite floor provided by the present invention is simple.

### BRIEF DESCRIPTION OF THE DRAWINGS

FIG. 1 is a structural schematic diagram I of a composite floor provided by an embodiment of the present invention.

FIG. 2 is a structural schematic diagram II of a composite floor provided by an embodiment of the present invention.

FIG. 3 is a structural schematic diagram III of a composite floor provided by an embodiment of the present invention.

FIG. 4 is a structural schematic diagram IV of a composite floor provided by an embodiment of the present invention.

FIG. 5 is a schematic diagram I of a split structure of a composite floor provided by an embodiment of the present invention.

FIG. 6 is a sectional view I of a composite floor provided by an embodiment of the present invention.

FIG. 7 is a schematic diagram II of a split structure of a composite floor provided by an embodiment of the present invention.

FIG. 8 is a sectional view II of a composite floor provided by an embodiment of the present invention.

FIG. 9 is a schematic diagram III of a split structure of a composite floor provided by an embodiment of the present invention.

FIG. 10 is a sectional view III of a composite floor provided by an embodiment of the present invention.

Reference signs in drawings are as follows: 1. decoration layer, 101. first decoration layer, 102. second decoration layer, 11. decoration groove, 12. decoration ridge, 2. supporting layer, 21. supporting ridge, and 22. supporting groove

### DETAILED DESCRIPTION OF THE EMBODIMENTS

Preferred embodiments of the present invention will be illustrated below in detail in combination with the drawings.

To achieve the objectives of the present invention, in some embodiments of a novel floor,

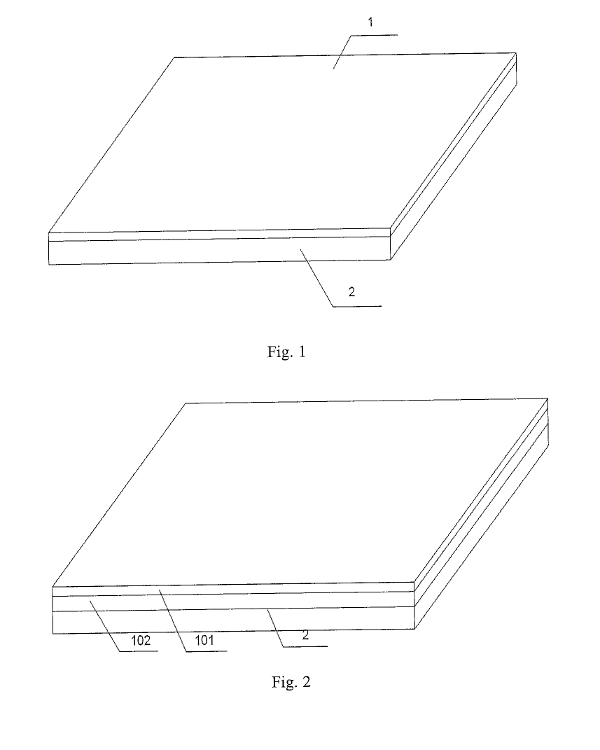

as shown in FIG. 1, a composite floor includes a decoration layer 1 and a supporting layer 2, wherein the supporting layer 2 is prepared from a plastic composition; the decoration layer 1 is very thin, and the decoration layer 1 can be prepared from one or more materials of wood, bamboo, scrimber and decorative paper. The composite floor is of a two-layer structure, wherein the supporting layer 2 includes a front face and a back face, and the front face of the supporting layer 2 is provided with the decoration layer 1.

The plastic composition is prepared from the following components in parts by weight: 30 parts of polyvinyl chloride, 55 parts of limestone powder, 0.5 part of polyurethane foaming agent and 0.5 part of calcium-zinc stabilizer. The plastic composition can further include some other components to improve the performance thereof. As the parts of the limestone powder are greater, the hardness of the plastic composition can be improved, and thus the plastic composition has better mechanical strength.

The decoration layer 1 is prepared from wood or bamboo, thereby being smooth, beautiful and elegant in appearance.

A preparation method of the composite floor, used for preparing the composite floor, includes the following steps:

(1) burdening: preparing materials according to 30 parts of polyvinyl chloride, 55 parts of limestone powder, 0.5 part of polyurethane foaming agent and 0.5 part of calcium-zinc stabilizer;

(2) mixing: performing heating and pressurization mixing on the polyvinyl chloride, the limestone powder, the polyurethane foaming agent and the calcium-zinc stabilizer to form a mixture;

(3) extrusion molding: forming a plastic composition from the mixture through an extrusion molding die;

(4) cooling: performing cooling forming on the plastic composition subjected to extrusion molding;

(5) cutting: cutting the plastic composition subjected to cooling forming to form a supporting layer;

(6) laminating: putting a decoration layer and the supporting layer in a press in sequence, coating contact surfaces of the decoration layer and the supporting layer with cold pressing glue, and laminating the decoration layer and the supporting layer by the press to form the composite floor.

As the supporting layer 2 of the composite floor provided by the present invention is prepared from the plastic composition, the composite floor has good anti-water, anti-insect and anti-mildew effects. Moreover, by means of the plasticity of the plastic composition, the composite floor is unlikely to deform and is longer in service life.

In order to further optimize the implementation effect of the present invention, in some other embodiments, the rest features are the same, and the difference therebetween lies in that the plastic composition is prepared from the following components in parts by weight: 55 parts of polyvinyl chloride, 35 parts of limestone powder, 0.5 part of polyurethane foaming agent and 0.5 part of calcium-zinc stabilizer.

As the parts of the 1 polyvinyl chloride are greater, the flexibility of the plastic composition can be improved.

In order to further optimize the implementation effect of the present invention, in some other embodiments, the rest features are the same, and the difference therebetween lies in that: to optimize the performance of the plastic composition, as being verified by a lot of experiments, preferably, the plastic composition is prepared from the following components in parts by weight: 45 parts of polyvinyl chloride, 45 parts of limestone powder, 0.5 part of polyurethane foaming agent and 0.5 part of calcium-zinc stabilizer. In this embodiment, the flexibility and the hardness of the plastic composition are unified, and the supporting layer 2 prepared from the same is firm in structure, unlikely to deform and is easy to process.

As shown in FIG. 2, in order to further optimize the implementation effect of the present invention, in some other embodiments, the rest features are the same, and the difference therebetween lies in that the composite floor is of a three-layer structure, the composite floor includes a second decoration layer 102 arranged on the surface of the supporting layer 2 and a first decoration layer 101 arranged on the surface of the second decoration layer 102, the thickness of the first decoration layer 101 is smaller than that of the second decoration layer 102, the first decoration layer 101 and the second decoration layer 102 are prepared from wood, bamboo or scrimber, but different in material. The composite floor provided by this embodiment has better optimized structure, better mechanical strength and better anti-water, anti-insect and anti-mildew effects and is more beautiful and elegant.

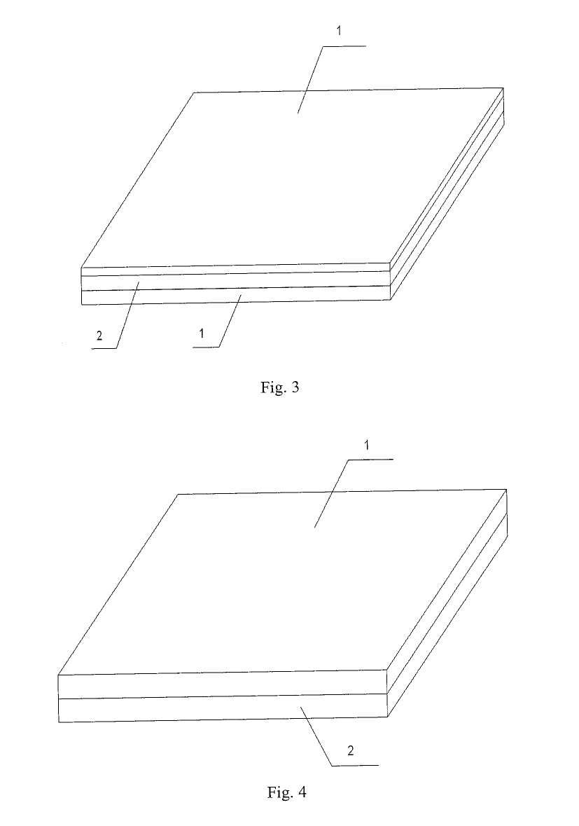

As shown in FIG. 3, in order to further optimize the implementation effect of the present invention, in some other embodiments, the rest features are the same, and the difference therebetween lies in that the composite floor is of a three-layer structure, the supporting layer 2 includes a front face and a back face, and the front face and the back face of the supporting layer 2 are both provided with the decoration layer 1 respectively. The structure is simple. The decoration layer 1 plays a decoration role, and the supporting layer 2 serving as a substrate of the composite floor plays a supporting role.

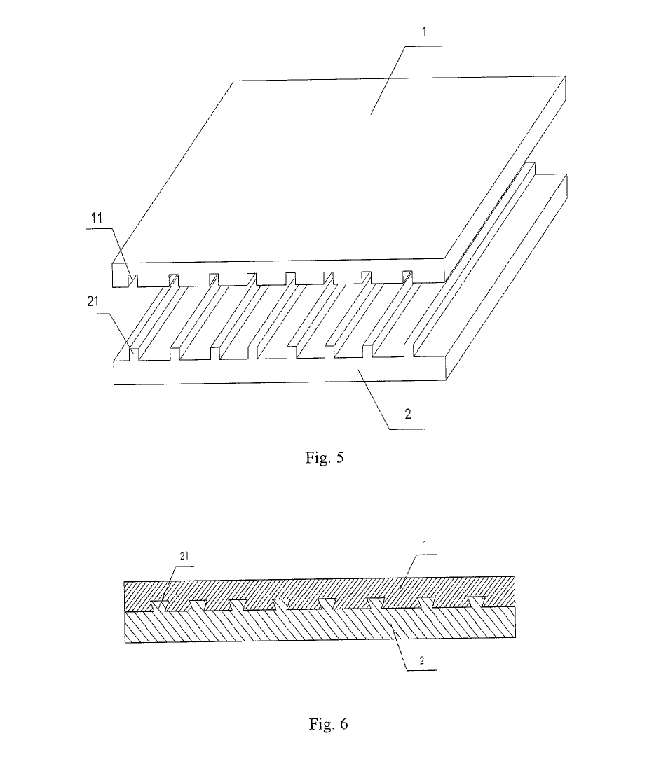

As shown in FIG. 4 and FIG. 5, in order to further optimize the implementation effect of the present invention, in some other embodiments, the rest features are the same, and the difference therebetween lies in that the decoration layer 1 is thicker, the front face of the supporting layer 2 is provided with supporting ridges 21, and the decoration layer 1 is provided with decoration grooves 11 matched with the supporting ridges 21. A firmer connection between the supporting layer 2 and the decoration layer 1 is guaranteed.

As shown in FIG. 6, in order to further optimize the implementation effect of the present invention, in some other embodiments, the rest features are the same, and the difference therebetween lies in that the decoration layer 1 is thicker, the front face of the supporting layer 2 is provided with the supporting ridges 21, the decoration layer 1 is provided with the decoration grooves 11 matched with the supporting ridges 21, and the section of each supporting ridge 21 is dovetail-shaped. A firmer connection between the supporting layer 2 and the decoration layer 1 is guaranteed.

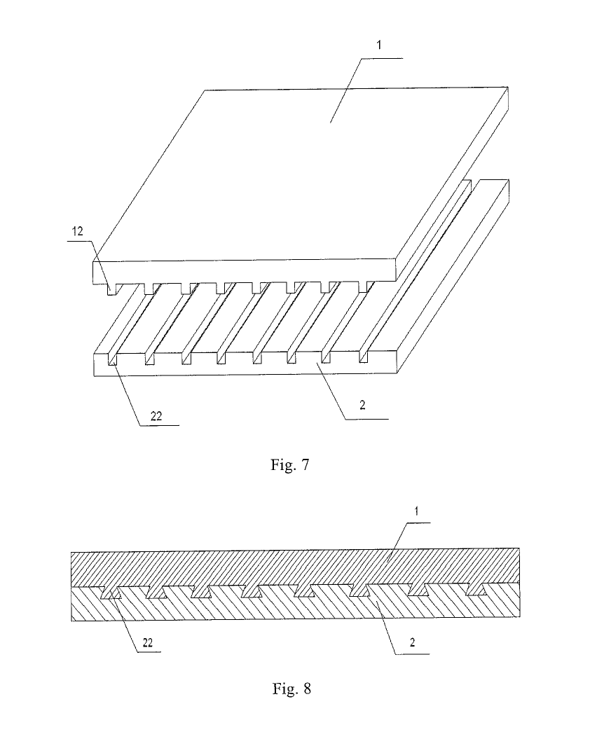

As shown in FIG. 7, in order to further optimize the implementation effect of the present invention, in some other embodiments, the rest features are the same, and the difference therebetween lies in that the decoration layer 1 is thicker, the front face of the supporting layer 2 is provided with supporting grooves 22, and the decoration layer 1 is provided with decoration ridges 12 matched with the supporting grooves 22.

A firmer connection between the supporting layer 2 and the decoration layer 1 is guaranteed.

As shown in FIG. 8, in order to further optimize the implementation effect of the present invention, in some other embodiments, the rest features are the same, and the difference therebetween lies in that the decoration layer 1 is thicker, the front face of the supporting layer 2 is provided with the supporting grooves 22, the decoration layer 1 is provided with the decoration ridges 12 matched with the supporting grooves 22, and the section of each supporting groove 22 is dovetail-shaped. A firmer connection between the supporting layer 2 and the decoration layer 1 is guaranteed.

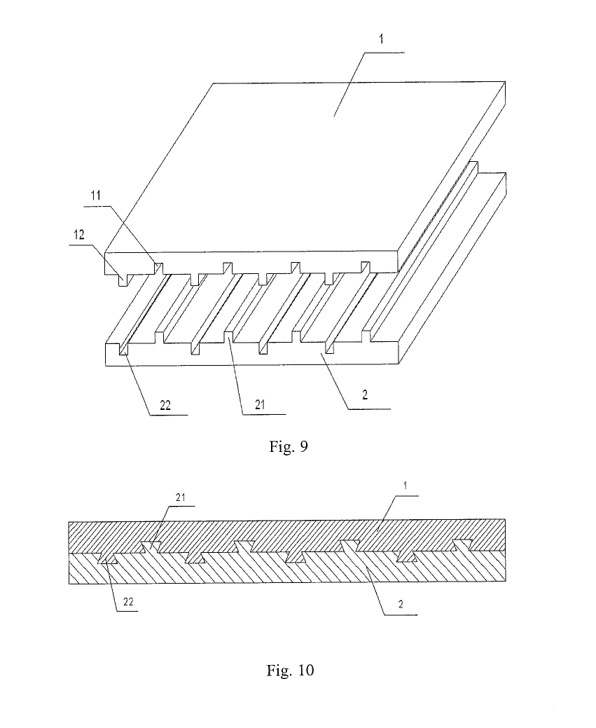

As shown in FIG. 9, in order to further optimize the implementation effect of the present invention, in some other embodiments, the rest features are the same, and the difference therebetween lies in that the decoration layer 1 is thicker, the front face of the supporting layer 2 is provided with the supporting ridges 21 and the supporting grooves 22, and the supporting ridges 21 and the supporting grooves 22 are arranged at equal intervals. A firmer connection between the supporting layer 2 and the decoration layer 1 is guaranteed, and the stress on each part of the supporting layer 2 and the decoration layer 1 is more uniform.

As shown in FIG. 10, in order to further optimize the implementation effect of the present invention, in some other embodiments, the rest features are the same, and the difference therebetween lies in that the decoration layer 1 is thicker, the front face of the supporting layer 2 is provided with the supporting ridges 21 and the supporting grooves 22, the supporting ridges 21 and the supporting grooves 22 are arranged at equal intervals, and the section of each supporting ridge 21 and the section of each supporting groove 22 are dovetail-shaped. A further connection between the supporting layer 2 and the decoration layer 1 is guaranteed, and the stress on each part of the supporting layer 2 and the decoration layer 1 is more uniform.

Novel preferred embodiments are shown, it should be noted that a variety of deformations and improvements can still be made for those of ordinary skill in the art without departing from the creative conception of the present invention, and these deformations and improvements all fall within the protection scope of the present invention.

1. A plastic composition, characterized by being prepared from the following components in parts by weight: 30-55 parts of polyvinyl chloride, 35-55 parts of limestone powder, 0.5-5 parts of polyurethane foaming agent and 0.5-5 parts of stabilizer.

2. The plastic composition of claim 1, wherein the stabilizer is a calcium-zinc stabilizer.

3. The plastic composition of claim 2, wherein preferably, the plastic composition is prepared from the following components in parts by weight: 35-50 parts of polyvinyl chloride, 40-50 parts of limestone powder, 0.5-2 parts of polyurethane foaming agent and 0.5-2 parts of stabilizer.

4. A composite floor, comprising a decoration layer and a supporting layer, wherein the supporting layer is prepared from the plastic composition of claim 1.

5. The composite floor of claim 4, wherein the decoration layer is prepared from one or more materials of wood, bamboo, scrimber and decorative paper.

6. The composite floor of claim 5, wherein the supporting layer comprises a front face and a back face, the front face of the supporting layer is provided with the decoration layer or the front face and the back face of the supporting layer are both provided with the decoration layer respectively.

7. The composite floor of claim 6, wherein the front face and/or the back face of the supporting layer is provided with supporting ridges and/or supporting grooves, and the decoration layer is provided with decoration grooves and/or decoration ridges matched with the supporting ridges and/or the supporting grooves.

8. The composite floor of claim 7, wherein the section of each supporting ridge and/or each supporting groove is dovetail-shaped.

9. The composite floor of claim 7, wherein the front face and/or the back face of the supporting layer is provided with the supporting ridges and the supporting grooves, and the supporting ridges and the supporting grooves are arranged at equal intervals.

10. A preparation method of a composite floor, used for preparing the composite floor of claim 4, comprising the following steps:
(1) burdening: preparing materials according to 30-55 parts of polyvinyl chloride, 35-55 parts of limestone powder, 0.5-5 parts of polyurethane foaming agent and 0.5-5 parts of stabilizer;
(2) mixing: performing heating and pressurization mixing on the polyvinyl chloride, the limestone powder, the polyurethane foaming agent and the stabilizer to form a mixture;
(3) extrusion molding: forming a plastic composition from the mixture through an extrusion molding die;
(4) cooling: performing cooling forming on the plastic composition subjected to extrusion molding;
(5) cutting: cutting the plastic composition subjected to cooling forming to form a supporting layer;
(6) laminating: putting a decoration layer and the supporting layer in a press in sequence, coating contact surfaces of the decoration layer and the supporting layer with cold pressing glue, and laminating the decoration layer and the supporting layer by the press to form the composite floor.
